(19) United States
(12) Patent Application Publication
(10) Pub. No.: US 2015/0353086 A1
(43) Pub. Date: Dec. 10, 2015

(54) CONTROL DEVICE FOR VEHICLE AND CONTROL METHOD FOR VEHICLE

(71) Applicant: TOYOTA JIDOSHA KABUSHIKI KAISHA, Toyota-shi (JP)

(72) Inventors: Shinji KATO, Toyota-shi (JP); Satoshi YAMANAKA, Susono-shi (JP); Hideaki OTSUBO, Aichi-gun (JP)

(73) Assignee: TOYOTA JIDOSHA KABUSHIKI KAISHA, Toyota-shi (JP)

(21) Appl. No.: 14/734,335

(22) Filed: Jun. 9, 2015

(30) Foreign Application Priority Data
Jun. 9, 2014 (JP) 2014-118987

(51) Int. Cl. B60W 30/14; B60W 10/02; B60W 10/08

(52) U.S. Cl. CPC B60W 30/143; B60W 10/08; B60W 10/02; B60W 2710/021; B60W 2710/06

(57) ABSTRACT

A control device for a vehicle includes a control unit. The control unit has a first traveling mode in which a power connection and disconnection device is engaged during traveling, a second traveling mode in which the power connection and disconnection device is released during traveling, and a third traveling mode. The control unit executes the second traveling mode when i) the vehicle speed is equal to or higher than the lower limit vehicle speed and equal to or lower than an upper limit vehicle speed, ii) an accelerator depressing amount is greater than a first depressing amount and smaller than a second depressing amount, and iii) an accelerator depressing amount variation is zero, or the control unit determines that a traveling condition is deceleration traveling based on the accelerator depressing amount variation.

### INCORPORATION BY REFERENCE

The disclosure of Japanese Patent Application No. 2014-118987 filed on Jun. 9, 2014 including the specification, drawings and abstract is incorporated herein by reference in its entirety.

### BACKGROUND OF THE INVENTION

1. Field of the Invention

The present invention relates to a control device for a vehicle and a control method for a vehicle capable of causing a vehicle to coast by cutting off power transmission between an engine and a driving wheel.

2. Description of Related Art

A vehicle which performs control on coasting is known. For example, Japanese Patent Application Publication No. 8-067174 (JP 8-067174 A) discloses a technique in which, when a throttle opening is greater than a fully closed state, a start clutch between an engine and a transmission is released and eco-run driving for placing the engine in an idling state is performed, when the throttle opening is greater than at the time of eco-run driving, normal driving is performed, and when the throttle opening is in the fully closed state, the start clutch is engaged and eco-run driving for stopping fuel supply to the engine is performed. International Publication No. 2013/046381 discloses a technique in which, when an accelerator returning speed at the time of an accelerator off operation is low (when a deceleration intention of a driver is weak), coasting traveling control is performed while an engine is operated, and when the accelerator returning speed at the time of the accelerator off operation is higher, fuel cut control is performed. Japanese Patent Application Publication No. 2012-219904 (JP 2012-219904 A) discloses a technique in which, when an accelerator depressing amount is zero, coasting traveling control and fuel cut control are switched according to a gradient of a traveling road while an engine is operated.

On the other hand, in the related art described above, coasting is performed according to a throttle opening or an accelerator depressing amount, or an accelerator depressing amount variation, or the like while the engine is operated. For example, in the technique described in JP 8-067174 A, an execution condition for coasting is established in a low-speed area, when the throttle opening is greater than the fully closed state, vehicle deceleration occurs with the release of the start clutch, and when the throttle opening is in the fully closed state, vehicle deceleration is likely to be increased by an engine brake with the engagement of the start clutch. For this reason, a driver is likely to feel a sense of discomfort for insufficient vehicle deceleration when the throttle opening is greater than the fully closed state.

### SUMMARY OF THE INVENTION

Accordingly, the invention provides a control device for a vehicle and a control method for a vehicle capable of suppressing a sense of discomfort of a driver while optimizing an execution area of coasting.

A control device for a vehicle according to an embodiment of the invention, the vehicle including an engine, a driving wheel, a power connection and disconnection device arranged between the engine and the driving wheel, includes a control unit. The control unit is configured to a first traveling mode in which the power connection and disconnection device is engaged during traveling, a second traveling mode in which the power connection and disconnection device is released during traveling, and a third traveling mode in which fuel supply to the engine is stopped in a state where the power connection and disconnection device is engaged when an accelerator depressing amount is zero during traveling, the control unit is configured to execute the first traveling mode when a vehicle speed is lower than a lower limit vehicle speed, and the control unit is configured to execute the second traveling mode when i) the vehicle speed is equal to or higher than the lower limit vehicle speed and equal to or lower than the upper limit vehicle speed, ii) the accelerator depressing amount is greater than a first depressing amount and smaller than a second depressing amount, and iii) an accelerator depressing amount variation is zero, or the control unit determines that a traveling condition is deceleration traveling based on the accelerator depressing amount variation.

The control unit may be configured to engage the power connection and disconnection device to allow acceleration traveling when the control unit determines that a traveling condition is acceleration traveling based on the accelerator depressing amount variation during traveling in the second traveling mode.

The control unit may be configured to display a range of the accelerator depressing amount in which the second traveling mode is executable and a present accelerator depressing amount on a display unit inside the vehicle.

The control unit may be configured to execute the first traveling mode when the vehicle speed is higher than the upper limit vehicle speed.

The control unit may be configured to execute the first traveling mode when the accelerator depressing amount is equal to or smaller than the first depressing amount or equal to or greater than the second depressing amount.

A control method for a vehicle, the vehicle including an engine, a driving wheel, a power connection and disconnection device arranged between the engine and the driving wheel, includes a control unit according to another embodiment of the invention executing a first traveling mode in which the power connection and disconnection device is engaged during traveling, executing a second traveling mode in which the power connection and disconnection device is released during traveling, and executing a third traveling mode in which fuel supply to the engine is stopped in a state where the power connection and disconnection device is engaged when an accelerator depressing amount is zero during traveling. The first traveling mode is executed when a vehicle speed is lower than a lower limit vehicle speed, and the second traveling mode is executed when i) the vehicle speed is equal to or higher than the lower limit vehicle speed and equal to or lower than an upper limit vehicle speed, ii) the accelerator depressing amount is greater than a first depressing amount and smaller than a second depressing amount, and iii) an accelerator depressing amount variation is zero, or the control unit determines that a traveling condition is deceleration traveling based on the accelerator depressing amount variation.

According to the control device for a vehicle and the control method for a vehicle of the invention, when the vehicle speed is lower than the lower limit vehicle speed, the second traveling mode is prohibited and the first traveling mode is executed. Therefore, it is possible to suppress a sense of discomfort of the driver due to insufficient vehicle deceleration in a low-speed area. According to the control device for a vehicle and the control method for a vehicle, when i) the vehicle speed is equal to or higher than the lower limit vehicle speed and equal to or lower than the upper limit vehicle speed, ii) the accelerator depressing amount is greater than the first depressing amount and smaller than the second depressing amount, and iii) the accelerator depressing amount variation is zero, or the control unit determines that a traveling condition is deceleration traveling based on the accelerator depressing amount variation, the second traveling mode is executed. In this way, according to the control device for a vehicle and the control method for a vehicle, it is possible to generate vehicle deceleration of proper magnitude in the low-speed area with optimizing the area where the second traveling mode is executed, and to suppress a sense of discomfort of the driver.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a control device for a vehicle and a control method for a vehicle according to the invention and a vehicle to which the control device for a vehicle and the control method for a vehicle are applied;

FIG. 2 is a diagram illustrating an N coasting area;

FIG. 3 is a flowchart illustrating traveling mode setting of the control device for a vehicle and the control method for a vehicle according to the invention;

FIG. 4 is a time chart illustrating traveling mode setting of the control device for a vehicle and the control method for a vehicle according to the invention; and

FIG. 5 is a diagram showing an example of an N coasting area displayed inside the vehicle.

### DETAILED DESCRIPTION OF EMBODIMENTS

Hereinafter, an example of a control device for a vehicle and a control method for a vehicle according to the invention will be described in detail referring to the drawings. It should be noted that the example is not intended to limit the invention.

### EXAMPLE

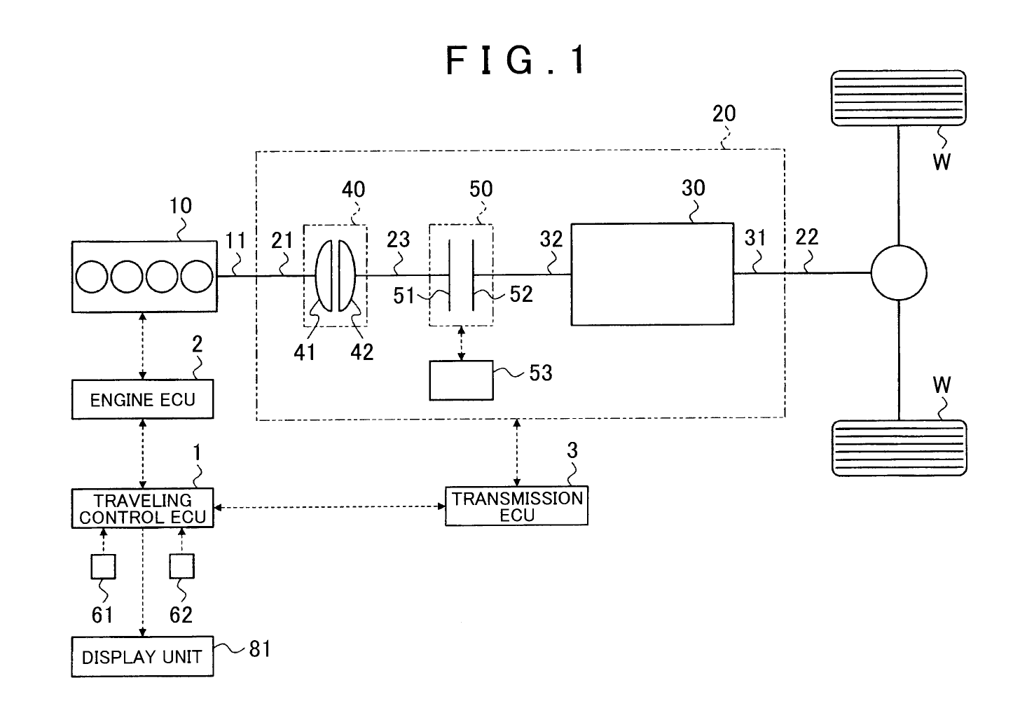

An example of a control device for a vehicle and a control method for a vehicle according to the invention will be described referring to FIGS. 1 to 5.

First, an example of a vehicle to which the control device for a vehicle and the control method for a vehicle are applied will be described.

As shown in FIG. 1, a vehicle illustrated herein is provided with an engine 10 as a power source, and an automatic transmission 20 which transmits power of the engine 10 to a driving wheel W side.

The vehicle is also provided with, as a control device for a vehicle, an electronic control device (hereinafter, referred to as “traveling control ECU”) 1 which performs control on traveling of the vehicle, an electronic control device (hereinafter, referred to as “engine ECU”) 2 which controls the engine 10, and an electronic control device (hereinafter, referred to as “transmission ECU”) 3 which controls the automatic transmission 20. The traveling control ECU 1, the engine ECU 2, and the transmission ECU 3 have various calculation processing functions performed by the control unit of the control device for a vehicle as described below. The traveling control ECU 1 transmits and receives detection information from sensors, calculation processing results, and the like to and from the engine ECU 2 or the transmission ECU 3. The traveling control ECU 1 sends a command to the engine ECU 2 or the transmission ECU 3 to cause the engine ECU 2 to execute the control of the engine 10 according to the command or to cause the transmission ECU 3 to execute the control of the automatic transmission 20 according to the command.

The engine 10 is an engine, such as an internal combustion engine, and generates power in an engine rotation shaft 11 by supplied fuel.

As the automatic transmission 20 which is mounted in the vehicle, for example, not only a general stepped automatic transmission or a continuously variable automatic transmission, but also a dual clutch transmission (DCT), a multimode manual transmission (MMT), or the like can be applied.

The automatic transmission 20 of the example is provided with a transmission body 30 as an automatic transmission part, and a torque converter 40 which transmits power of the engine 10 to the transmission body 30.

In the automatic transmission 20, a transmission input shaft 21 is coupled to the engine rotation shaft 11, and a transmission output shaft 22 is coupled to the driving wheel W side. The transmission input shaft 21 is connected to a pump impeller 41 of the torque converter 40 so as to be rotatable integrally. A counter shaft 23 is connected to a turbine runner 42 of the torque converter 40 so as to be rotatable integrally. The transmission output shaft 22 is connected to a rotation shaft 31 of the transmission body 30 on the driving wheel W side. The torque converter 40 may be provided with a lock-up clutch (not shown).

The vehicle is also provided with a power connection and disconnection device 50 which is arranged between the engine 10 and the driving wheel W (that is, on a power transmission path of power output from the engine 10) to enable transmission and cutoff of power between the engine 10 and the driving wheel W.

The power connection and disconnection device 50 has a first engagement part 51 and a second engagement part 52 respectively connected to the engine 10 side and the driving wheel W side on the power transmission path. The power connection and disconnection device 50 enables power transmission between the engine 10 and the driving wheel W in an engagement state where the first engagement part 51 and the second engagement part 52 are rotated integrally. The power connection and disconnection device 50 cuts off power transmission between the engine 10 and the driving wheel W in a release state where the first engagement part 51 and the second engagement part 52 are rotated separately.

The power connection and disconnection device 50 causes an actuator 53 to execute the engagement operation or the release operation between the first engagement part 51 and the second engagement part 52. The actuator 53 controls the connection state and the separation state between the first engagement part 51 and the second engagement part 52.

In the vehicle, the power connection and disconnection device 50 is controlled during traveling, whereby power can be transmitted between the engine 10 and the driving wheel W during traveling, or power transmission can be cut off during traveling.

The power connection and disconnection device 50 may be newly provided between the engine 10 and the driving wheel W, or a device arranged between the engine 10 and the driving wheel W for another use may be used. In the vehicle of the example, the power connection and disconnection device 50 is provided in the automatic transmission 20. Here, a power connection and disconnection device which controls the automatic transmission 20 in a neutral state is used as the power connection and disconnection device 50 of the example. For example, when the automatic transmission 20 is a general stepped automatic transmission, at least one of a plurality of power connection and disconnection devices (clutch or brake) provided in the transmission body 30 is used as the power connection and disconnection device 50. For example, when the automatic transmission 20 is a belt-type continuously variable automatic transmission, a clutch (so-called start clutch) of a forward-backward movement switching mechanism arranged between the torque converter 40 and the transmission body 30 is used as the power connection and disconnection device 50.

In FIG. 1, the continuously variable automatic transmission is exemplified. For this reason, the first engagement part 51 is connected to the counter shaft 23. The second engagement part 52 is connected to a rotation shaft 32 of the transmission body 30 on the engine 10 side. In this case, the power connection and disconnection device 50 is a friction clutch in which a friction material is provided in at least one of the first engagement part 51 and the second engagement part 52. In the following description, the power connection and disconnection device 50 is referred to as a clutch 50. The clutch 50 supplies hydraulic oil to at least one of the first engagement part 51 and the second engagement part 52, whereby the first engagement part 51 and the second engagement part 52 come into contact with each other and are placed in the engagement state. The clutch 50 discharges the supplied hydraulic oil, whereby the first engagement part 51 and the second engagement part 52 are separated from each other and placed in the release state. The actuator 53 is provided with, for example, an electromagnetic valve (not shown), and supply oil pressure of hydraulic oil to the clutch 50 is adjusted by the opening/closing operation of the electromagnetic valve by a clutch control unit (power connection and disconnection control unit) of the transmission ECU 3. The clutch control unit (power connection and disconnection control unit) operates as the control unit of the control device for a vehicle.

Next, the calculation processing of the control device for a vehicle will be described.

The control unit in the control device for a vehicle has a first traveling mode in which clutch 50 is engaged during traveling, a second traveling mode in which the clutch 50 is released during traveling, and a third traveling mode in which fuel supply to the engine 10 is stopped in a state where the clutch 50 is engaged during traveling. The first traveling mode is a traveling mode in normal traveling described below. The second traveling mode is a traveling mode in coasting traveling described below. The third traveling mode is a traveling mode at the time of fuel cut control in which fuel supply to the engine 10 is stopped in normal traveling.

The vehicle of the example can coast (perform coasting traveling) when the clutch 50 is released and power transmission between the engine 10 and the driving wheel W is cut off. To this end, the traveling control ECU 1 has a coasting control unit which executes control (hereinafter, referred to as “coasting control”) on coasting traveling. The coasting control unit sends a command to the transmission ECU 3 to release the clutch 50 during normal traveling, thereby cutting off power transmission between the engine 10 and the driving wheel W during traveling. The normal traveling refers to a state where the clutch 50 is engaged and power transmission between the engine 10 and the driving wheel W is enabled for traveling. The normal traveling is executed by a normal traveling control unit of the traveling control ECU 1. The coasting control unit or the normal traveling control unit operates as the control unit of the control device for a vehicle.

Specifically, the vehicle of the example can execute neutral coasting traveling (hereinafter, referred to as “N coasting traveling”) as coasting traveling. The N coasting traveling is coasting traveling in which power transmission between the engine 10 and the driving wheel W is cut off while the engine 10 is operated. To this end, the coasting control unit releases the clutch 50 when the execution condition of the N coasting traveling is established. The coasting control unit operates the engine 10 at an idling speed during the N coasting traveling. The coasting control unit executes control (hereinafter, referred to as “N coasting control”) on the N coasting traveling.

The N coasting traveling is executed when a combination of a vehicle speed V and an accelerator depressing amount Ap is in an N coasting area.

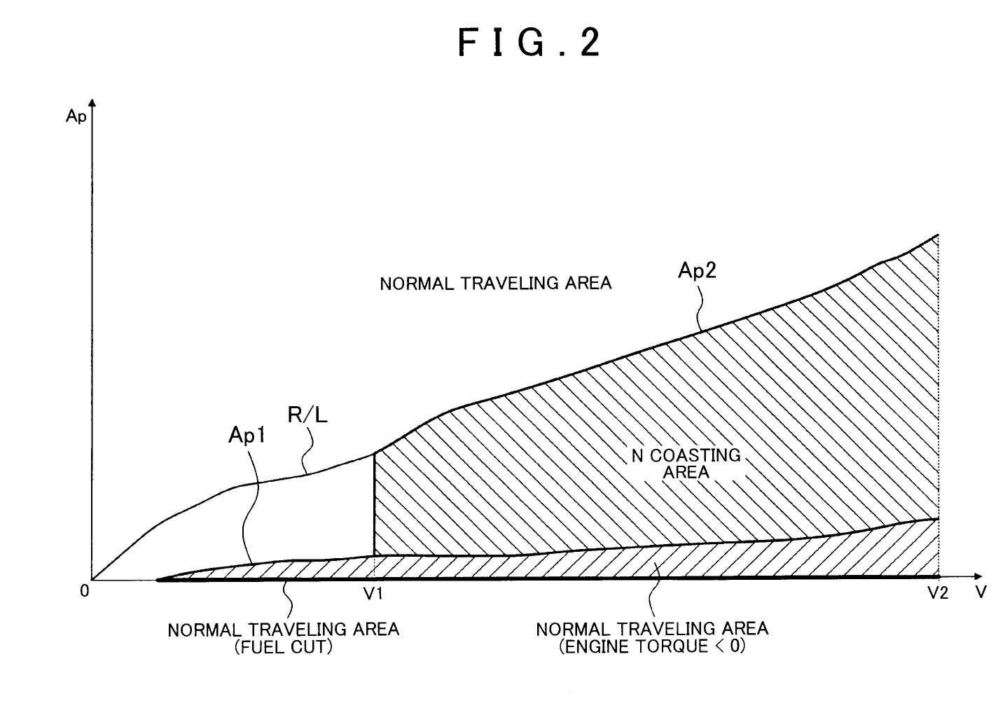

In the example, as shown in FIG. 2, a lower limit vehicle speed V1 and an upper limit vehicle speed V2 defining the N coasting area are set. In N coasting traveling, it is not possible to obtain sufficient vehicle deceleration when a vehicle speed V is low. The sufficient vehicle deceleration is determined according to, for example, a target user of the vehicle, or the like. For this reason, in the example, a lower limit value of the vehicle speed V capable of generating desired vehicle deceleration by N coasting traveling is set as the lower limit vehicle speed V1. In N coasting traveling, when the vehicle speed V is high, vehicle traveling resistance increases. Accordingly, the vehicle deceleration increases. For this reason, in a high-speed area where vehicle deceleration becomes greater than a predetermined value, a decrease in vehicle speed V along with N coasting traveling is great compared to an area where the vehicle speed V is low, and there is a possibility of immediate deceleration to a vehicle speed V0 for returning the vehicle from N coasting traveling to normal traveling. Therefore, in the example, the vehicle speed V at which the vehicle deceleration is the predetermined value is set as the upper limit vehicle speed V2.

In the example, as shown in FIG. 2, a first depressing amount Ap1 and a second depressing amount Ap2 defining the N coasting area are set. The first depressing amount Ap1 is a maximum value of an accelerator depressing amount Ap for each vehicle speed V when output torque (engine torque) of the engine 10 is negative. The second depressing amount Ap2 is an accelerator depressing amount Ap for each vehicle speed V necessary for maintaining constant speed traveling. The second depressing amount Ap2 for each vehicle speed V is an accelerator depressing amount Ap corresponding to a road load line (R/L line) where constant speed traveling for each vehicle speed V is possible.

A traveling mode adjustment unit of the traveling control ECU 1 determines that the combination of the vehicle speed V and the accelerator depressing amount Ap is in the N coasting area when the vehicle speed V is equal to or higher than the lower limit vehicle speed V1 and equal to or lower than the upper limit vehicle speed V2 (V1≦V≦V2), and the accelerator depressing amount Ap is greater than the first depressing amount Ap1 and smaller than the second depressing amount Ap2 (Ap1<Ap<Ap2). For this reason, the traveling mode adjustment unit selects an N coasting traveling mode and permits the execution of N coasting traveling. When the execution of N coasting traveling is permitted, the coasting control unit executes the N coasting control to cause the vehicle to perform N coasting traveling. However, even if the combination of the vehicle speed V and the accelerator depressing amount Ap is in the N coasting area, when the accelerator depressing amount Ap changes in a depressing direction, it is desirable to allow acceleration traveling in a normal traveling mode. Accordingly, when the combination of the vehicle speed V and the accelerator depressing amount Ap is in the N coasting area, and a variation (hereinafter, referred to as “accelerator depressing amount variation”) dAp in the accelerator depressing amount Ap indicates constant speed traveling (0) or deceleration traveling, the traveling mode adjustment unit selects the N coasting traveling mode and permits the execution of N coasting traveling. Even if the combination of the vehicle speed V and the accelerator depressing amount Ap is in the N coasting area, when the accelerator depressing amount variation dAp indicates acceleration traveling (that is, the accelerator depressing amount variation dAp during coasting traveling indicates acceleration traveling), the traveling mode adjustment unit prohibits the execution of N coasting traveling and permits the execution of the normal traveling mode. That is, in this case, the clutch 50 is engaged in the normal traveling mode to allow acceleration traveling. In this way, the traveling mode adjustment unit determines the availability of executing N coasting traveling. The traveling mode adjustment unit operates as the control unit of the control device for a vehicle.

The vehicle deceleration changes according to vehicle traveling resistance even if the combination of the vehicle speed V and the accelerator depressing amount Ap is the same. For this reason, it is desirable that the threshold values (lower limit vehicle speed V1, upper limit vehicle speed V2, first depressing amount Ap1, second depressing amount Ap2) defining the N coasting area change according to the vehicle traveling resistance. The vehicle travel resistance changes according to the number of occupants in the vehicle and the load. Therefore, the control device for a vehicle and the control method for a vehicle can set a proper N coasting area according to the number of occupants in the vehicle and the load.

The vehicle in the example can execute fuel cut control for stopping fuel supply to the engine 10 during normal traveling. The traveling mode adjustment unit or the normal traveling control unit permits the execution of the fuel cut control when the execution condition of the fuel cut control is established (as described below, when the accelerator depressing amount Ap is zero), and sends a command to execute the fuel cut control to a fuel cut control unit of the traveling control ECU 1. The fuel cut control unit operates as the control unit of the control device for a vehicle. The fuel cut control is control which is executed in the normal traveling mode. For this reason, the fuel cut control unit sends the command to execute the fuel cut control to the engine ECU 2 in a traveling state where the clutch 50 is engaged. The engine ECU 2 stops fuel supply to the engine 10 based on the execution command. In this way, during the fuel cut control, power transmission between the engine 10 and the driving wheel W is enabled. Accordingly, vehicle deceleration by an engine brake is generated. When the execution condition of the fuel cut control is established, if the vehicle is not returned from N coasting traveling to normal traveling, instead of the normal traveling control unit, the fuel cut control unit may send a command to engage the clutch 50 to the transmission ECU 3 to engage the clutch 50 in the release state.

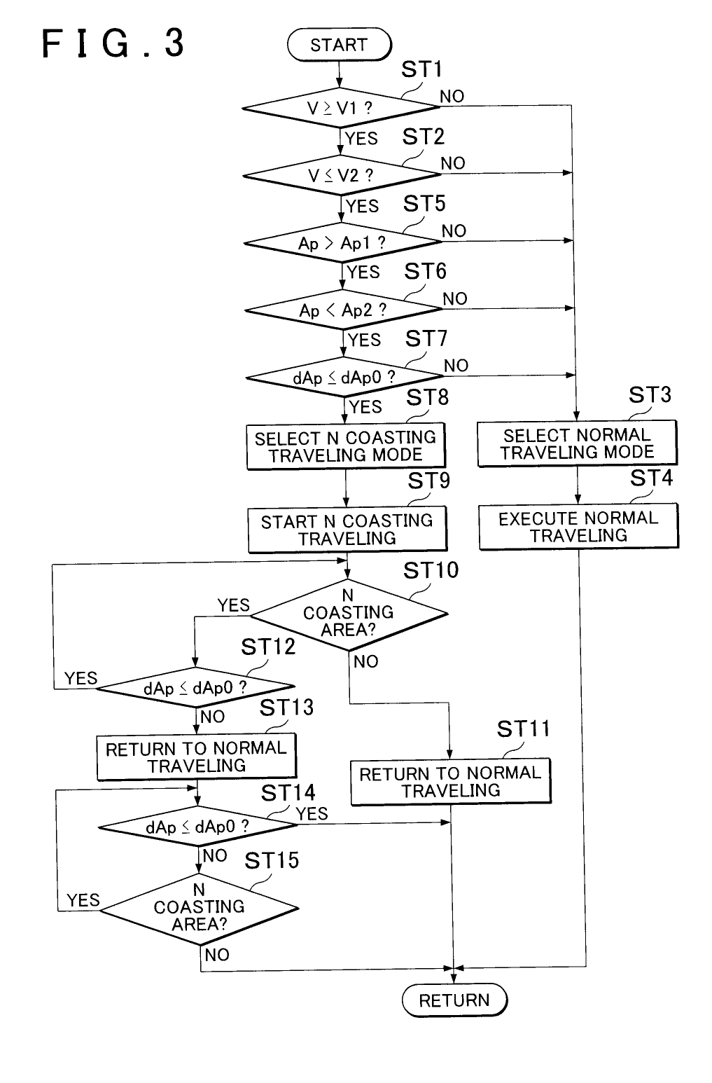

Hereinafter, a calculation processing operation of the control device for a vehicle will be described referring to the flowchart of FIG. 3.

The traveling mode adjustment unit determines whether or not the vehicle speed V detected by a vehicle speed sensor 61 is equal to or higher than the lower limit vehicle speed V1 (Step ST1). When the vehicle speed V is equal to or higher than the lower limit vehicle speed V1, the traveling mode adjustment unit determines whether or not the vehicle speed V is equal to or lower than the upper limit vehicle speed V2 (Step ST2).

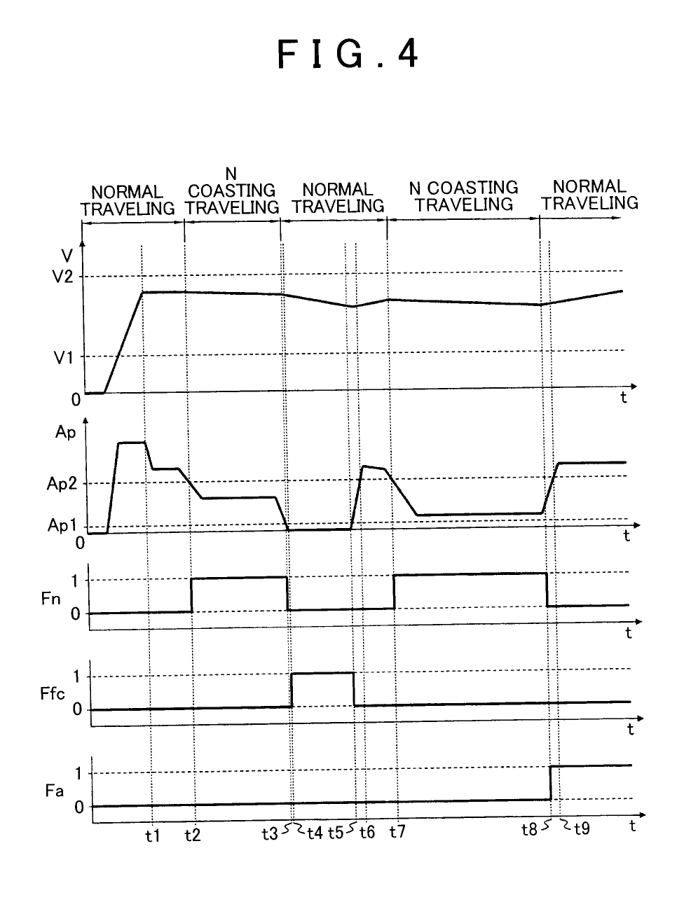

When the vehicle speed V is lower than the lower limit vehicle speed V1 or is higher than the upper limit vehicle speed V2, the traveling mode adjustment unit prohibits the execution of N coasting traveling, permits the execution of normal traveling, and selects the normal traveling mode (Step ST3). In this case, the normal traveling control unit executes normal traveling (Step ST4). The traveling mode adjustment unit returns to Step ST1. When the normal traveling mode is selected, as shown in FIG. 4, the traveling mode adjustment unit turns off an N coasting flag Fn (Fn=0). When the N coasting traveling mode is selected, the traveling mode adjustment unit turns on the N coasting flag Fn (Fn=1).

When the vehicle speed V is equal to or higher than the lower limit vehicle speed V1 and equal to or lower than the upper limit vehicle speed V2, the traveling mode adjustment unit determines whether or not the accelerator depressing amount Ap detected by an accelerator depressing amount sensor 62 is greater than the first depressing amount Ap1 (Step ST5). When the accelerator depressing amount Ap is greater than the first depressing amount Ap1, the traveling mode adjustment unit determines whether or not the accelerator depressing amount Ap is smaller than the second depressing amount Ap2 (Step ST6).

When the accelerator depressing amount Ap is equal to or smaller than the first depressing amount Ap1, the traveling mode adjustment unit progresses to Step ST3 and selects the normal traveling mode. At this time, in the case of the accelerator depressing amount Ap (0<Ap≦Ap1) with negative engine torque, the normal traveling control unit executes normal traveling. At this time, if the accelerator depressing amount Ap (0<Ap≦Ap1) is obtained with a decrease of accelerator depressing amount Ap, the vehicle is returned from N coasting traveling to normal traveling. For this reason, in the case of returning from N coasting traveling, the normal traveling control unit sends a command to the transmission ECU 3 and causes the clutch control unit to engage the clutch 50 in the release state. When the accelerator depressing amount Ap is zero (Ap=0), the normal traveling control unit sends a command to execute the fuel cut control to the fuel cut control unit and causes the fuel cut control unit to execute the fuel cut control. In this case, control for placing the clutch 50 in the engagement state is already executed. As shown in FIG. 4, the traveling mode adjustment unit turns on a fuel cut flag Ffc (Ffc=1) when the fuel cut control is selected in the normal traveling mode and turns off the fuel cut flag Ffc (Ffc=0) when the fuel cut control is not selected.

Even when the accelerator depressing amount Ap is equal to or greater than the second depressing amount Ap2, the traveling mode adjustment unit progresses to Step ST3 and selects the normal traveling mode.

When the accelerator depressing amount Ap is greater than the first depressing amount Ap1 and smaller than the second depressing amount Ap2, the traveling mode adjustment unit determines whether or not the accelerator depressing amount variation dAp is equal to or smaller a predetermined value dAp0 (>0) (Step ST7). The predetermined value dAp0 is a threshold value for determining whether or not the driver requests acceleration traveling of the vehicle by an accelerator operation, and is substantially a value close to zero. When the accelerator depressing amount variation dAp is greater than the predetermined value dAp0, it is determined that the driver requests acceleration traveling of the vehicle. In this case, as shown in FIG. 4, the traveling mode adjustment unit turns on an accelerator depression determination flag Fa (Fa=1). Meanwhile, when the accelerator depressing amount variation dAp is equal to or smaller than the predetermined value dAp0 (including when the accelerator depressing amount variation dAp is zero or negative), it is determined that the driver requests constant speed traveling or deceleration traveling without requesting acceleration traveling of the vehicle. In this case, as shown in FIG. 4, the traveling mode adjustment unit turns off the accelerator depression determination flag Fa (Fa=0). In Step ST7, it may be determined whether or not the accelerator depressing amount variation per unit time is smaller than the predetermined value, thereby determining whether or not the driver requests acceleration traveling of the vehicle by quick depression of the accelerator pedal.

When the accelerator depressing amount variation dAp is greater than the predetermined value dAp0, the combination of the vehicle speed V and the accelerator depressing amount Ap is in the N coasting area; however, acceleration traveling is requested. Accordingly, the traveling mode adjustment unit progresses to Step ST3 and selects the normal traveling mode.

When the accelerator depressing amount variation dAp is equal to or smaller than the predetermined value dAp0, the traveling mode adjustment unit permits the execution of N coasting traveling and selects the N coasting traveling mode (Step ST8). With this, the coasting control unit starts N coasting traveling (Step ST9).

The traveling mode adjustment unit determines whether or not it is the N coasting area (that is, the combination of the vehicle speed V and the accelerator depressing amount Ap is in the N coasting area) during N coasting traveling (Step ST10). The determination is performed by executing all of the determinations of Steps ST1, ST2, ST5, and ST6. Accordingly, when the vehicle speed V is equal to or higher than the lower limit vehicle speed V1, the vehicle speed V is equal to or lower than the upper limit vehicle speed V2, the accelerator depressing amount Ap is greater than the first depressing amount Ap1, and the accelerator depressing amount Ap is smaller than the second depressing amount Ap2, the traveling mode adjustment unit determines that it is the N coasting area. When the vehicle speed V is lower than the lower limit vehicle speed V1, the vehicle speed V is higher than the upper limit vehicle speed V2, the accelerator depressing amount Ap is equal to or smaller than the first depressing amount Ap1, or the accelerator depressing amount Ap is equal to or greater than the second depressing amount Ap2, the traveling mode adjustment unit determines that it is not the N coasting area (that is, the combination of the vehicle speed V and the accelerator depressing amount Ap is out of the N coasting area).

When it is not the N coasting area, the traveling mode adjustment unit selects the normal traveling mode and returns the vehicle from N coasting traveling to normal traveling (Step ST11). Then, the traveling mode adjustment unit returns to Step ST1.

When it is the N coasting area, as in Step ST7, the traveling mode adjustment unit determines whether or not the accelerator depressing amount variation dAp is equal to or smaller than the predetermined value dAp0 (Step ST12).

When the accelerator depressing amount variation dAp is equal to or smaller than the predetermined value dAp0, the traveling mode adjustment unit returns to Step ST10 while continuing N coasting traveling.

Meanwhile, when the accelerator depressing amount variation dAp is greater than the predetermined value dAp0, since the driver requests acceleration traveling, even if it is the N coasting area, the traveling mode adjustment unit selects the normal traveling mode and returns the vehicle from N coasting traveling to normal traveling (Step ST13).

Thereafter, the traveling mode adjustment unit again determines whether or not the accelerator depressing amount variation dAp is equal to or smaller than the predetermined value dAp0 (Step ST14). When the accelerator depressing amount variation dAp is greater than the predetermined value dAp0, since the acceleration request of the driver is continuing, as in Step ST10, the traveling mode adjustment unit determines whether or not it is the N coasting area while continuing normal traveling (Step ST15). When it is still the N coasting area, the traveling mode adjustment unit returns to Step ST14 while continuing normal traveling. When it is not the N coasting area (that is, the combination of the vehicle speed V and the accelerator depressing amount Ap is out of the N coasting area), the traveling mode adjustment unit returns to Step ST1 while continuing normal traveling.

When it is determined in Step ST14 that the accelerator depressing amount variation dAp is equal to or smaller than the predetermined value dAp0, since there is a possibility that the driver requests N coasting traveling, the traveling mode adjustment unit returns to Step ST1. With this, according to the control device for a vehicle and the control method for a vehicle, N coasting traveling can be executed again if a condition is established even after the vehicle is returned to normal traveling. Therefore, according to the control device for a vehicle and the control method for a vehicle, it becomes possible to expand a situation (area) in which fuel efficiency is improved.

For example, as shown in the time chart of FIG. 4, during a period between the time t1 and the time t2, an accelerator pedal returning operation is performed; however, since the accelerator depressing amount Ap is equal to or greater than the second depressing amount Ap2, normal traveling is performed (the same applies to a period between the time t6 and the time t7). During a period between the time t2 and the time t3, since the combination of the vehicle speed V and the accelerator depressing amount Ap is in the N coasting area, N coasting traveling is performed (the same applies to a period between the time t7 and the time t8). During a period between the time t4 and the time t5, since the accelerator depressing amount Ap is zero, the fuel cut control is performed. During a period between the time t8 and the time t9, the combination of the vehicle speed V and the accelerator depressing amount Ap is in the N coasting area; however, since the accelerator depressing amount variation dAp is equal to or greater than the predetermined value dAp0, normal traveling is performed. The time t8 is the time when it is determined that the accelerator depressing amount variation dAp is equal to or greater than the predetermined value dAp0. That is, there is a slight time difference from when the accelerator depressing amount variation dAp is equal to or greater than the predetermined value dAp0 until the determination is performed.

As described above, in a low-speed area where the vehicle speed is lower than the lower limit vehicle speed V1, vehicle deceleration by N coasting traveling is not sufficiently obtained. For this reason, even if N coasting traveling is executed in the low-speed area, there is a possibility that the driver feels a sense of discomfort in vehicle deceleration with respect to the accelerator operation of the driver. Accordingly, in the control device for a vehicle and the control method for a vehicle of the example, the lower limit vehicle speed V1 at which N coasting traveling is executed is set, and when the vehicle speed is lower than the lower limit vehicle speed V1, N coasting traveling is prohibited. That is, according to the control device for a vehicle and the control method for a vehicle, in the low-speed area, the release operation of the clutch 50 to execute N coasting traveling and the engagement operation of the clutch 50 to return the vehicle from N coasting traveling to normal traveling are not frequently performed. Accordingly, according to the control device for a vehicle and the control method for a vehicle, it is possible to suppress a sense of discomfort of the driver due to insufficient vehicle deceleration or repetition of engagement and release of the clutch 50 in the low-speed area.

In a high-speed area where the vehicle speed is higher than the upper limit vehicle speed V2, as described above, vehicle deceleration is great compared to the N coasting area or the low-speed area. Accordingly, if N coasting traveling is executed in the high-speed area, there is a possibility that N coasting traveling and normal traveling are frequently switched. For this reason, there is a possibility that the driver feels a sense of discomfort. Therefore, in the control device for a vehicle and the control method for a vehicle of the example, the upper limit vehicle speed V2 at which N coasting traveling is executed is set, and when the vehicle speed is higher than the upper limit vehicle speed V2, N coasting traveling is prohibited. That is, according to the control device for a vehicle and the control method for a vehicle, in the high-speed area, the release operation of the clutch 50 to execute N coasting traveling and the engagement operation of the clutch 50 to return the vehicle from N coasting traveling to normal traveling are not frequently performed. Consequently, according to the control device for a vehicle and the control method for a vehicle, it is possible to suppress a sense of discomfort of the driver due to excessive vehicle deceleration or repetition of engagement and release of the clutch 50 in the high-speed area.

In this way, according to the control device for a vehicle and the control method for a vehicle, it is possible to generate vehicle deceleration of proper magnitude in the low-speed area or the high-speed area with optimizing the N coasting area, and to suppress a sense of discomfort of the driver. Furthermore, according to the control device for a vehicle and the control method for a vehicle, it is possible to achieve expansion of the N coasting area in a vehicle speed area between the low-speed area and the high-speed area.

In general, at the time of high-speed traveling, the frequency of traveling with the accelerator depressing amount Ap being zero is low. For this reason, even if N coasting traveling is set to be executed with accelerator off (Ap=0) by the driver as a trigger, in the vehicle, the frequency of executing N coasting traveling is low. In the related art, it may be set that N coasting traveling is executed in the area of the accelerator depressing amount Ap with negative engine torque. Since the area of the accelerator depressing amount Ap is narrow, in the vehicle, the accelerator operation of the driver who intends to perform N coasting traveling is difficult, and the frequency of executing N coasting traveling is low. However, in the control device for a vehicle and the control method for a vehicle of the example, it is possible to select the N coasting traveling mode at the time of the accelerator depressing amount Ap (Ap1<Ap<Ap2) with a high frequency of use by the driver according to the vehicle speed V. For this reason, according to the control device for a vehicle and the control method for a vehicle, it is possible to select the coasting traveling mode by a simple accelerator operation of the driver. Therefore, it is possible to increase the frequency of executing N coasting traveling and to improve fuel efficiency compared to the related art.

In the control device for a vehicle and the control method for a vehicle of the example, when decelerating the vehicle, the fuel cut control is selected in the normal traveling mode when the accelerator depressing amount Ap is zero (Ap=0), the coasting traveling mode is selected at the time of the accelerator depressing amount Ap (Ap1<Ap<Ap2) with a high frequency of use by the driver according to the vehicle speed V, and the normal traveling mode is selected at the time of the accelerator depressing amount Ap (0<Ap≦Ap1) with negative engine torque during the fuel cut control and the coasting traveling mode. For this reason, according to the control device for a vehicle and the control method for a vehicle, it is possible to use deceleration by the engine brake of the fuel cut control, deceleration by the engine brake in an area with negative engine torque, and deceleration by N coasting traveling in a state close to a road load state according to the accelerator depressing amount Ap.

In the control device for a vehicle and the control method for a vehicle of the example, when the accelerator operation is performed in the acceleration direction, even if it is the N coasting area, it is possible to prohibit N coasting traveling while giving priority to the acceleration intention of the driver. When the prohibition control is not executed, N coasting traveling is continued until the combination of the vehicle speed V and the accelerator depressing amount Ap is out of the N coasting area. Consequently, according to the control device for a vehicle and the control method for a vehicle of the example, N coasting traveling is prohibited with the detection of the acceleration intention of the driver, and the vehicle is returned from N coasting traveling to normal traveling, whereby it is possible to accelerate the vehicle with excellent responsiveness. Therefore, it is possible to suppress a sense of discomfort of the driver.

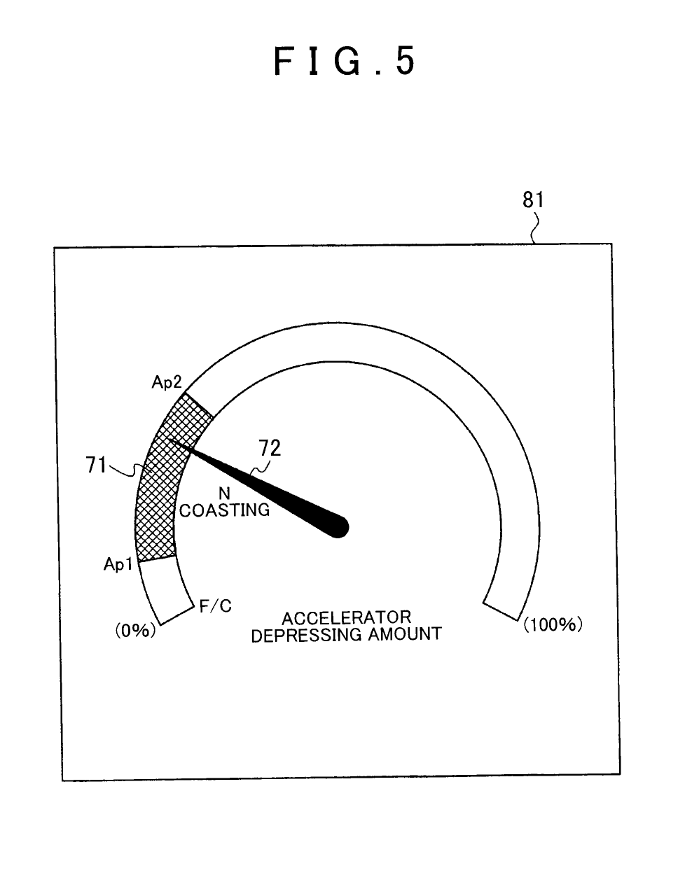

On the other hand, according to the control device for a vehicle and the control method for a vehicle of the example, the availability of executing N coasting traveling under the present condition is shown to the driver, and the driver can execute the N coasting traveling by the intention of the driver. For example, as shown in FIG. 5, the display control unit of the traveling control ECU 1 displays the range (Ap1<Ap<Ap2) 71 of the accelerator depressing amount Ap in the N coasting area according to the present vehicle speed V on a display unit 81 inside the vehicle. The display control unit operates as the control unit of the control device for a vehicle. The display unit 81 is, for example, a monitor (a monitor of a car navigation system or the like) arranged in a display area of an instrument panel or around a driver's seat, or the like. The range 71 of the accelerator depressing amount Ap in which N coasting traveling is executable changes according to the present vehicle speed V. On the display unit 81, an indicator 72 indicating the present accelerator depressing amount Ap is displayed along with the range 71 of the accelerator depressing amount Ap. The range 71 and the indicator 72 show the availability of executing N coasting traveling to the driver, and are desirably displayed constantly. However, the range 71 may disappear when the present accelerator depressing amount Ap is out of the range 71, such that the combination of the vehicle speed V and the accelerator depressing amount Ap being out of the N coasting area is clearly shown to the driver. In the example of FIG. 5, the accelerator depressing amount Ap is expressed as a percentage. In the example of FIG. 5, a fuel cut area (F/C) when the accelerator depressing amount Ap is zero is also shown.

In the example, the above-described control is performed based on the accelerator depressing amount Ap. However, the control may be executed using a throttle opening Tap having a unique relationship with the accelerator depressing amount Ap. At this time, the threshold values (first depressing amount Ap1, second depressing amount Ap2) in the above example are replaced with the corresponding threshold values (first opening Tap1, second opening Tap2) of the throttle opening Tap.

In the example, N coasting traveling is exemplified as coasting traveling. However, in coasting traveling, there is coasting traveling (so-called free-run traveling) in which power transmission between the engine 10 and the driving wheel W is cut off in a state where the engine 10 is stopped. For this reason, when the vehicle of the example performs free-run traveling, control in which N coasting traveling is replaced with free-run traveling may be executed, and the same functional effects as the above description can be obtained. In regard to the control, in the above description, “N coasting” is changed to “free-run”. However, in this case, when starting free-run traveling, the stop control of the engine 10 is performed, and the restart control of the engine 10 is applied when returning the vehicle from free-run traveling to normal traveling.

What is claimed is:

1. A control device for a vehicle, the vehicle including an engine, a driving wheel and
a power connection and disconnection device arranged between the engine and the driving wheel, the control device comprising:
a control unit configured to have a first traveling mode in which the power connection and disconnection device is engaged during traveling, a second traveling mode in which the power connection and disconnection device is released during traveling, and a third traveling mode in which fuel supply to the engine is stopped in a state where the power connection and disconnection device is engaged when an accelerator depressing amount is zero during traveling, wherein
the control unit is configured to execute the first traveling mode when a vehicle speed is lower than a lower limit vehicle speed, and
the control unit is configured to execute the second traveling mode when i) the vehicle speed is equal to or higher than the lower limit vehicle speed and equal to or lower than an upper limit vehicle speed, ii) the accelerator depressing amount is greater than a first depressing amount and smaller than a second depressing amount, and iii) an accelerator depressing amount variation is zero, or the control unit determines that a traveling condition is deceleration traveling based on the accelerator depressing amount variation.

2. The control device for the vehicle according to claim 1,
wherein the control unit is configured to engage the power connection and disconnection device to allow acceleration traveling when the control unit determines that a traveling condition is acceleration traveling based on the accelerator depressing amount variation during traveling in the second traveling mode.

3. The control device for the vehicle according to claim 1,
wherein the control unit is configured to display a range of the accelerator depressing amount in which the second traveling mode is executable and a present accelerator depressing amount on a display unit inside the vehicle.

4. The control device for the vehicle according to claim 1,
wherein the control unit is configured to execute the first traveling mode when the vehicle speed is higher than the upper limit vehicle speed.

5. The control device for the vehicle according to claim 4,
wherein the control unit is configured to execute the first traveling mode when the accelerator depressing amount is equal to or smaller than the first depressing amount or equal to or greater than the second depressing amount.

6. A control method for a vehicle, the vehicle including an engine, a driving wheel, a power connection and disconnection device arranged between the engine and the driving wheel, and a control unit, the control method comprising:
executing a first traveling mode in which the power connection and disconnection device is engaged during traveling;
executing a second traveling mode in which the power connection and disconnection device is released during traveling; and
executing a third traveling mode in which fuel supply to the engine is stopped in a state where the power connection and disconnection device is engaged during traveling,
wherein the first traveling mode is executed when a vehicle speed is lower than a lower limit vehicle speed, and
the second traveling mode is executed when i) the vehicle speed is equal to or higher than the lower limit vehicle speed and equal to or lower than an upper limit vehicle speed, ii) an accelerator depressing amount is greater than a first depressing amount and smaller than a second depressing amount, and iii) an accelerator depressing amount variation is zero, or the control unit determines that a traveling condition is deceleration traveling based on the accelerator depressing amount variation.
